(19) United States
(12) Patent Application Publication
(10) Pub. No.: US 2016/0124785 A1
(43) Pub. Date: May 5, 2016

(54) SYSTEM AND METHOD OF SAFETY MONITORING FOR EMBEDDED SYSTEMS

(71) Applicant: Siemens Aktiengesellschaft, Munich (DE)

(72) Inventor: Kun Ji, Plainsboro, NJ (US)

(21) Appl. No.: 14/528,135

(22) Filed: Oct. 30, 2014

(51) Int. Cl. G06F 11/07; G06F 13/42

(52) U.S. Cl. CPC G06F 11/079; G06F 11/0784; G06F 11/0721; G06F 13/4282

(57) ABSTRACT

The safety and integrity of an embedded computer system is monitored using an independent safety monitoring module in communication with the main controller module via a serial connection to a safety monitoring module proxy in the main controller module. The main controller module is monitored through the use of alive-telegram exchanges and computational challenges. The safety monitoring module also receives temperature information and supply voltage information about the main controller module. The monitored information may be evaluated using a prognostic model constructed using a simulation of failure modes off line.

### BACKGROUND OF THE INVENTION

1. Field of the Invention

The invention relates to embedded computer systems; i.e., computer systems having a dedicated function within a larger mechanical or electrical system. More particularly, embodiments disclosed herein relate to embedded computer systems having self-diagnostic and safety monitoring features.

2. Description of the Prior Art

Embedded systems are widely used in consumer, industrial, automotive, medical, commercial and military applications. As use herein, an embedded system is a dedicated computer system within a larger electrical or electromechanical system. It is embedded as part of a complete device often including hardware and mechanical parts. Compared with a general-purpose computer, an embedded computer typically is small, has low power consumption, may be hardened for use in harsh environments, and has a low per-unit cost. Those features typically come at the price of limited processing resources.

Current embedded systems lack self-diagnostic or safety monitoring functions for monitoring health information of the hardware and software and predicting and preventing possible future system failure. That restraint has limited the application of embedded systems in some safety critical industries such as the transportation industry.

A need exists in the art for an embedded system solution that includes self-diagnostic and safety monitoring features for use in safety-critical applications

A further need exists for a low-cost self-monitoring embedded system.

An additional need exists in the art for a method for self-monitoring an embedded system in which the monitoring processor and the main processor perform mutual integrity checks.

### SUMMARY OF THE INVENTION

An object of embodiments of the invention is the self-monitoring and self-diagnosis of an embedded system. Meeting that objective will permit the use of such an embedded system in applications where safety and dependability are concerns.

Another object of embodiments of the invention is to provide a self-monitoring and self-diagnosing embedded system that is compact and low-cost.

A further object of embodiments of the invention is the diagnosis of actual and potential failures in an embedded system with a prognostic model constructed using simulated failure modes.

These and other objects are achieved in one or more embodiments of the invention including systems, computer readable media and methods described herein. Embodiments of the systems, computer readable media and methods provide a self-monitoring embedded computer system.

In embodiments, a method is provided for monitoring a status of an embedded computer system comprising a main controller module and a safety monitoring module independent from the main controller module. At the safety monitoring module, via a serial interconnection between the safety monitoring module and a proxy sub-module of the main controller module, diagnostic information relating to the main controller module is received. Based on the diagnostic information, a determination is made by the safety monitoring module whether a failure condition is developing in the main controller module. The safety monitoring module then transmits to the main controller module, via the serial interconnection, a message relating to the failure condition.

In other embodiments, an embedded computer system is provided. The embedded computer system includes a main controller processing unit and main controller computer readable media containing computer readable instructions that, when executed by the main controller processing unit, cause the main controller processing unit to control an electromechanical system. The main controller processing unit includes a safety monitoring module proxy sub-module for performing communication tasks.

The embedded computer system further includes a safety monitoring processing unit independent from the main controller processing unit and in communication with the main controller processing unit via a serial interconnection between the safety monitoring processing unit and the proxy sub-module of the main controller processing unit. Computer readable media contains computer readable instructions that, when executed by the safety monitoring processing unit, cause the safety monitoring processing unit to perform the following operations: receiving, via the serial interconnection, diagnostic information relating to the main controller processing unit; determining, based on the diagnostic information, whether a failure condition is developing in the main controller processing unit; and transmitting to the main controller processing unit, via the serial interconnection, a message relating to the failure condition.

In additional embodiments, a non-transitory computer-usable medium is provided, having computer readable instructions stored thereon for execution by a safety monitoring processing unit of an embedded computer system, to perform operations for monitoring safety of the embedded computer system. The operations include receiving, via a serial interconnection between the safety monitoring processing unit and a proxy sub-module of a main controller processing unit, diagnostic information relating to the main controller processing unit; based on the diagnostic information, determining whether a failure condition is developing in the main controller processing unit; and transmitting to the main controller processing unit, via the serial interconnection, a message relating to the failure condition.

The respective objects and features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 is a schematic block diagram showing an embedded system architecture according to embodiments of the disclosure.

FIG. 2 is a table showing a format of a telegram between the safety monitoring processing unit and the main controller processing unit according to embodiments of the disclosure.

FIG. 3A is a time line showing communications between the safety monitoring processing unit and the main controller processing unit according to embodiments of the disclosure.

FIG. 3B is a time line showing communications between the safety monitoring processing unit and the main controller processing unit according to other embodiments of the disclosure.

FIG. 4 is a table showing a format of a firmware update telegram according to embodiments of the disclosure.

FIG. 5 is a table showing a telegram types according to embodiments of the disclosure.

FIG. 6 is a table showing a format of a data head of a firmware update telegram according to embodiments of the disclosure.

FIG. 7 is a flow chart showing a communication task according to embodiments of the disclosure.

FIG. 8 is a flow chart showing an alive check task according to embodiments of the disclosure.

FIG. 9 is a sequence diagram showing startup of a main controller processing unit according to embodiments of the disclosure.

FIG. 10 is a sequence diagram showing a runtime communication task with the safety monitoring processing unit according to embodiments of the disclosure.

FIG. 11 is a sequence diagram showing a firmware update for the safety monitoring module, according to embodiments of the disclosure.

FIG. 12 is a block diagram showing a process for monitoring an embedded computer system, according to embodiments of the disclosure.

To facilitate understanding, identical reference numerals have been used, where possible, to designate identical elements that are common to the figures.

### DETAILED DESCRIPTION

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. For example, the particulars regarding communications and data exchange between the processing units are shown by way of illustration and not by way of limitation, to clearly describe certain features and aspects of the present invention set out in greater detail herein. The various aspects of the present invention described more fully herein may include other communication protocols and messaging formats. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

Proposed herein is a self-diagnostic embedded computer system that utilizes a separate module or processing unit as a safety monitoring module (SMM) which diagnoses the system using real-time prognostic information, and predicts possible future failures according to failure patterns generated off-line.

Embedded systems often reside in machines that are expected to run continuously for years without errors and, in some cases, are expected to recover by themselves if an error occurs. The reliability of the system depends on how the system can monitor safety, detect errors, and then take safety measures to avoid significant consequences and losses. Presently disclosed is a new self-prognostic solution for embedded systems. The embedded system's health status is monitored and diagnosed internally by a safety engine inside the embedded system. Based on system failure modes and patterns simulated offline, the safety engine also predicts future failures to prevent sudden system failure which may have significant consequences.

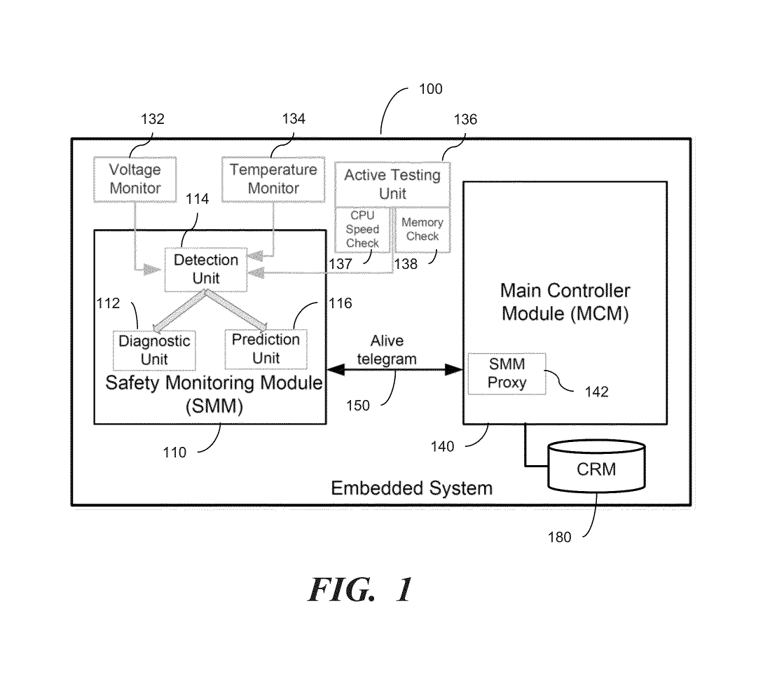

The disclosed embedded computer system 100, shown schematically in FIG. 1, comprises two independent modules or processing units 110, 140. The main controller module (MCM) 140 is the main processing unit providing the primary functionality for controlling and monitoring the electrical or electromechanical system in which the system 100 is embedded. The main controller module 140 also monitors and validates the integrity of a safety monitoring module (SMM) 110. The SMM 110 monitors and validates the physical boundary conditions (e.g. voltage and temperatures) of the embedded system 100 as well as the integrity of the MCM 140. The MCM processing unit 140 has a SMM proxy sub-module 142 for communicating with the SMM 110 via a communications link 150, and for sharing the health information of the MCM and the SMM.

The safety monitoring module 110 includes a detection unit 114, a diagnostic unit 112, and a prediction unit 116. The SMM 110 additionally implements prognostic algorithms. The detection unit 114 quantitatively measures embedded system performance degradation such as CPU speed and memory usage, and detects sudden system malfunctions. The detection unit 114 also localizes contributing source(s) of a given failure or anomaly. The diagnostics unit 112 identifies the types of faults by interpreting the characteristics of input-output patterns. The prediction unit 116 predicts the future behavior of the embedded system. For example, the prediction unit may evaluate the possibility of cascading failures. Results from the diagnostics unit 112 and the prediction unit 116 are sent to a human machine interface (HMI) (not shown) specific to the MCM 140 to notify or alarm the user.

A temperature monitor 134 measures the temperature of the processing units 110, 140 and feeds the data to the detection unit 114 of the SMM 110. A voltage monitor 132 measures the supply voltage of the CPUs and feeds the data to the detection unit 114 of the SMM 110.

An active testing unit 136 includes modules for CPU speed check 127 and memory check 138. Those modules utilize test results from monitoring performed via the link 150, as described below.

One or both of the modules 110, 140 includes a data memory that stores data used during execution of programs in the modules 110, 140, and is also used as a program work area. The data memory also functions as a program memory for storing programs executing in the modules 110, 140. The programs may also reside on any tangible, non-volatile computer-readable media 180 as computer readable instructions stored thereon for execution by the processing modules to perform the operations.

Generally, program modules executed in the processing modules 110, 140 include routines, objects, components, data structures and the like that perform particular tasks or implement particular abstract data types. The term “program” as used herein may connote a single program module or multiple program modules acting in concert.

An exemplary program module for implementing the methodology disclosed herein may be stored in the computer readable media 180 and read into a main memory of the processors from the computer readable media. In the case of a program stored in a memory media, execution of sequences of instructions in the module causes the processor to perform the process operations described herein. The embodiments of the present disclosure are not limited to any specific combination of hardware and software and the computer program code required to implement the foregoing can be developed by a person of ordinary skill in the art.

The term “computer-readable medium” as employed herein refers to a tangible, non-transitory machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. The terms “tangible media” and “non-transitory media” each exclude propagated signals, which are not tangible and are not non-transitory. Cached information is considered to be stored on a computer-readable medium. Common expedients of computer-readable media are well-known in the art and need not be described in detail here.

The detection unit 114 of the safety monitoring module 110 monitors the embedded system 100 for a variety of failure modes. Possible embedded system failure modes include, but are not limited to, CPU overheating due to poor heat dissipation, memory error such as stack overflow and underflow, thread suspension or stop due to memory leak or network communication failure, CPU speed performance degradation due to low supply voltage, and so on. Those failure modes can be simulated off line and used to construct a prognostic model of the embedded system.

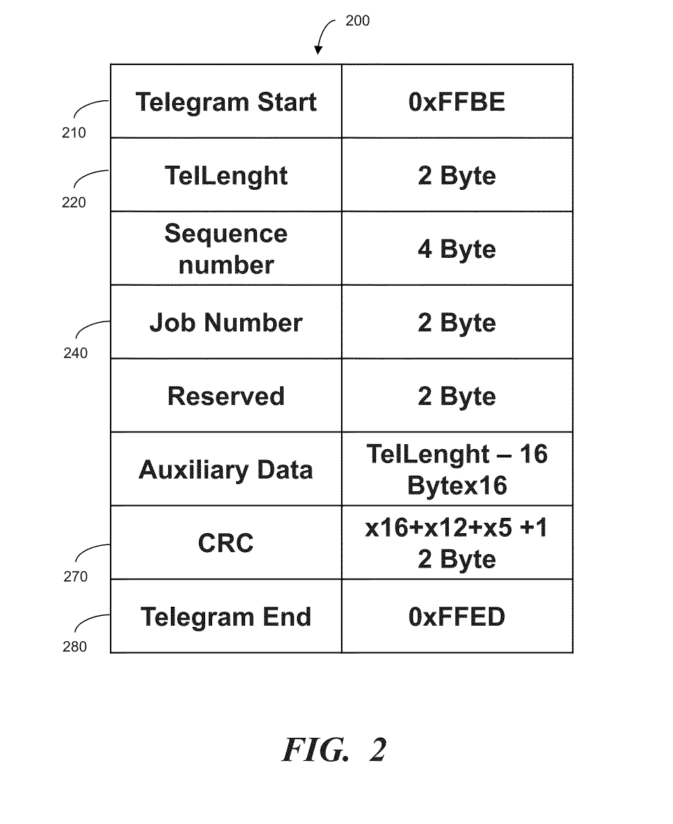

Communications between the SMM 110 and the MCM 140 are conducted over the link 150. In embodiments of the proposed invention, the communications between the MCM and the SMM utilize a serial protocol. That communication protocol is described with reference to the telegram format 200 shown in FIG. 2. Telegrams are used to exchange data between the SMM and the MCM for different purposes as indicated in the job number field 240 within the telegram.

The telegrams are secured by a checksum to ensure that the telegram that is received and interpreted is the same as the one that was send and intended to be triggered. The following security mechanisms are used:
Verification of telegram header 210, telegram end 280, and telegram length 220;
Communication error check by CRC Checksum 270;
Different job numbers 240 indicate different tasks to be done by the telegram receiver.
   If any error is detected in the serial communication, the SMM and the MCM will trigger a safe state transition.

Safety monitoring is performed using an alive telegram exchange and a calculation challenge. Each of those safety monitoring mechanisms is described below in turn.

In embodiments of the present disclosure, the MCM processing unit 140 and the SMM processing unit 110 monitor each other's general integrity via handshakes. For example, they may exchange alive-telegrams every second. If an alive-telegram is not received for more than 2 seconds, the MCM 140 will assume a non-responsive SMM 110, and vice versa.

In addition to the alive-telegrams, the MCM 140 and the SMM 110 also exchange their current system times and current states, as well as a challenge that is calculated on the MCM. The current state from the SMM also includes temperature and voltage states that are stored in the SMM proxy.

Embodiments of the present disclosure include the calculation of challenges that are used to test the integrity of the MGM's CPU. Those challenges may be embedded in the alive telegrams between the SMM and the MCM, and are originated by the SMM. The challenges are transmitted from the SMM to the MCM, which calculates results and sends the results back to the SSM. At the SSM, the results are compared to results stored in the SMM.

One possible format of the challenge calculation is:

Result=(Paramer1+Paramer2)*Paramer2,

where Paramer1 and Paramer2 are two numbers sent by the SMM to the MCM. Result is sent back to the SMM by the MCM.

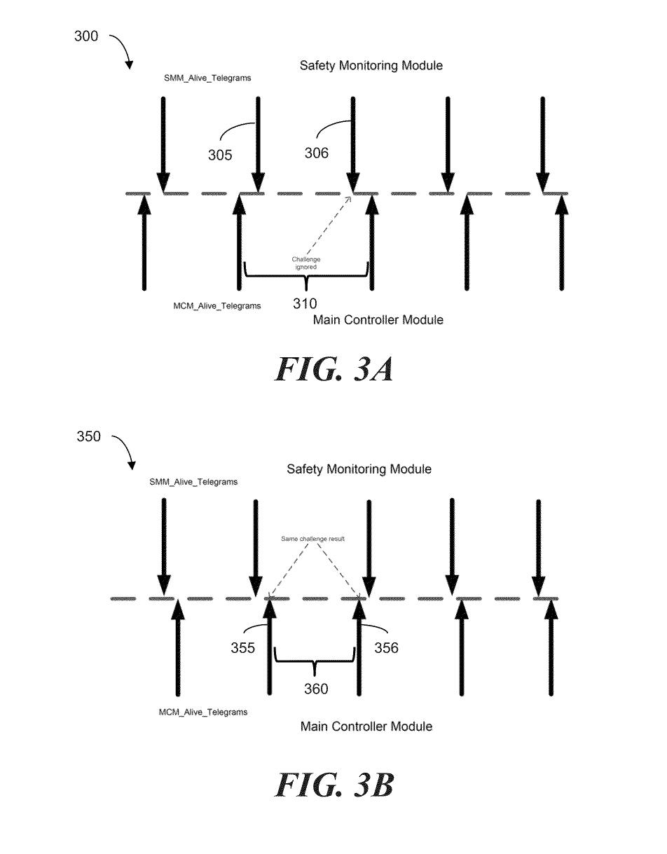

Because there is no send and reply mechanism in the serial communication between the SMM and the MCM, the two alive-telegrams may be out of sync due to the different time and clock base used in the two processes. Two valid scenarios 300, 350, shown in FIGS. 3A and 3B, respectively, must be considered when dealing with the challenge in the alive telegrams.

In the example 300 shown in FIG. 3A, the main controller module becomes out of sync, and two SMM alive-telegram challenge requests 305, 306 are received during one MCM alive period 310. In that case, the second challenge request 306 is simply ignored, since SMM does not send new challenges until it receives a correct response to the previous challenge request.

In the example 350 shown in FIG. 3B, the safety monitoring module becomes out of sync, and an MCM alive-telegram 356 contains the same challenge result sent in the previous alive telegram 355 since no SMM alive-telegram challenge request was received in the last MCM alive period 360. The SMM simply ignores the challenge result contained in the alive-telegram 356.

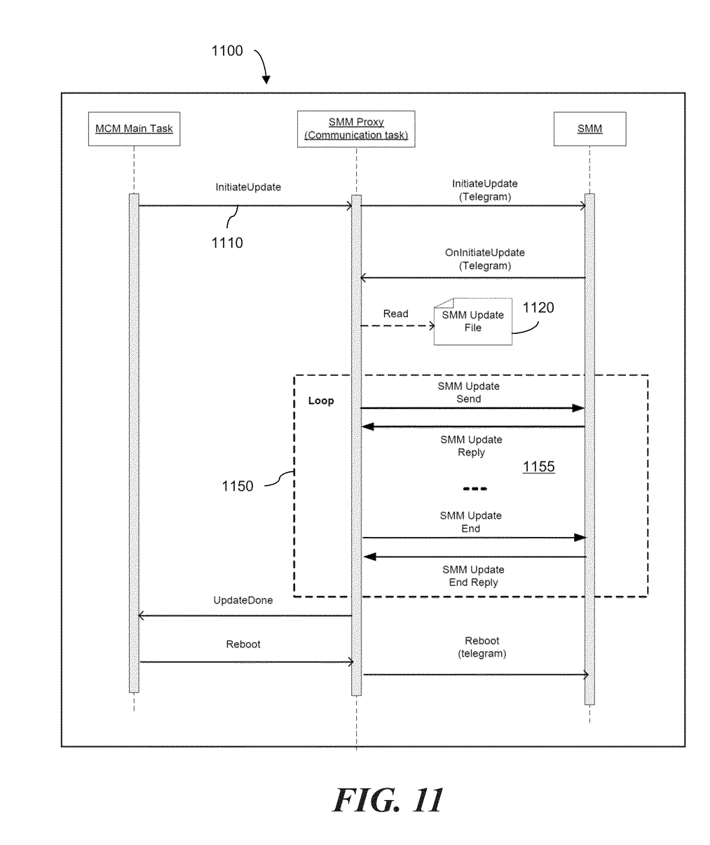

In embodiments of the present disclosure, a safety monitoring module firmware update is executed as a special case, as shown in the flow chart 1100 of FIG. 11. The SMM firmware update process does not follow the telegram format defined in the previous section with reference to FIG. 2 due to the fact that the data payload is fairly large (about 40 k) and must be transferred in a loop operation 1150. The process is initiated by the MCM main task via a command 1110, and an update file 1120 is made available to the SMM proxy.

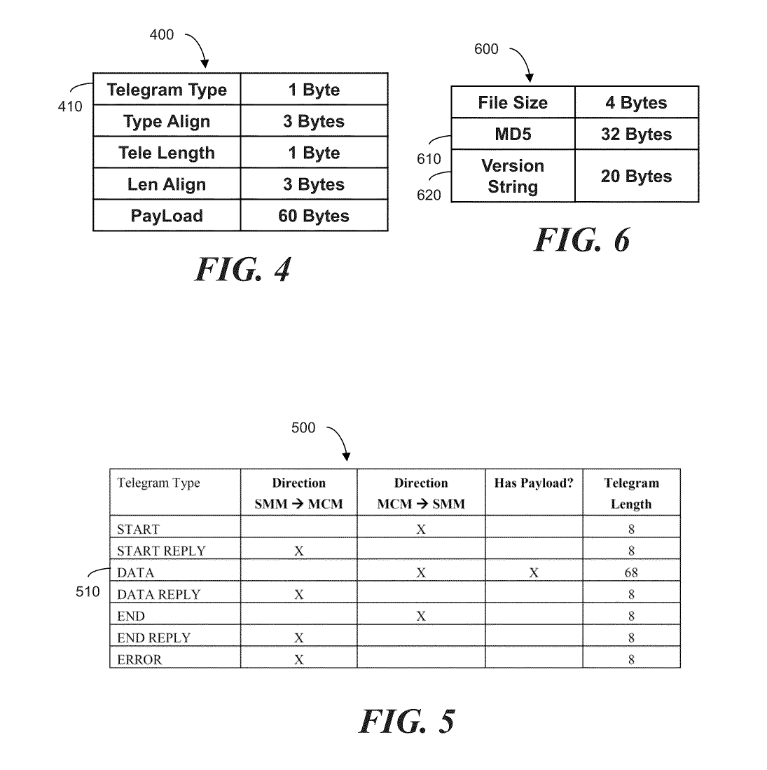

The SMM update process uses a two way (send+reply) communication protocol 1155, using a simplified telegram format 400 as shown in FIG. 4. The telegram type 410 is selected from one of the 7 telegram types used in the update process and shown in the table 500 of FIG. 5. Only the DATA telegram type 510 is used for payload, the remaining telegram types being used in initiation, handshaking and error handling.

The first DATA type telegram includes a data head 600, as shown in FIG. 6, in the first payload. The data head 600 includes checksum information 610 and version information 620 about the update file.

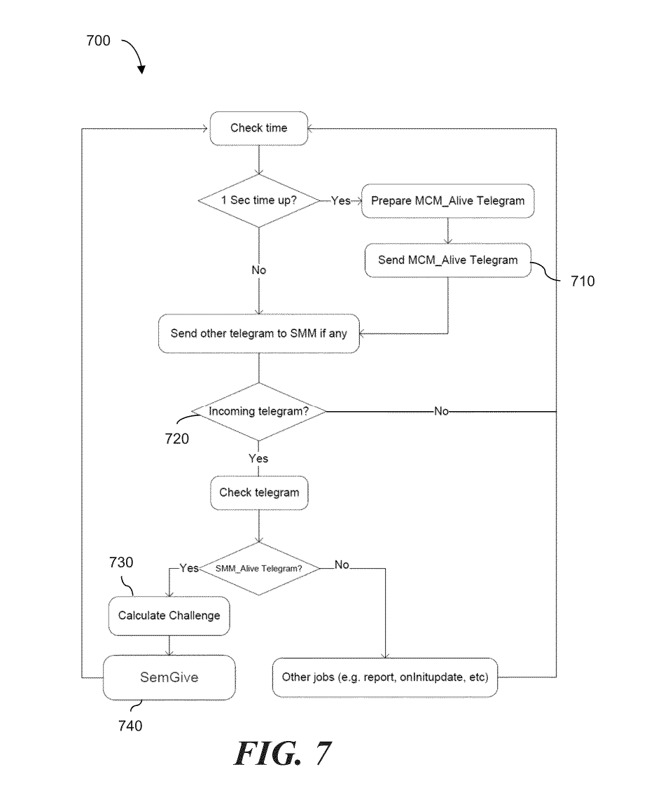

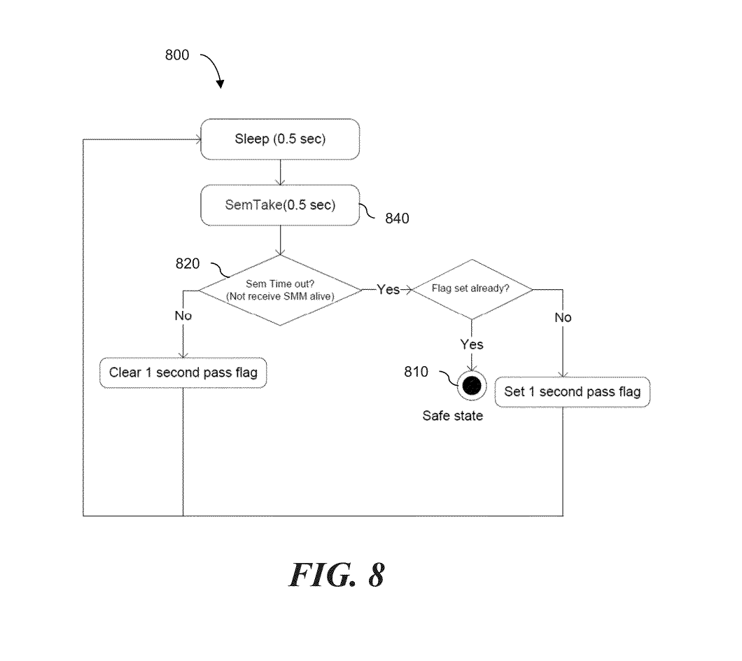

In embodiments of the present disclosure, the SMM proxy in the MCM side has two tasks: a cyclic communication task 700, illustrated by the flow chart of FIG. 7, and an MCM health condition monitoring task including an alive check task 800, illustrated by the flow chart of FIG. 8. Each will be discussed in turn.

1) The cyclic communication task 700 has a cycle time of about 10 ms and oversees serial communications with the SMM. The cyclic communication task has the same priority as the MCM main task so the alive telegram exchange with the SMM is allocated sufficient CPU time even when the MCM main task occupies most of the CPU time. With the same priority as the MCM main task, the cyclic communication task 700 also verifies whether there is sufficient CPU time left for MCM main task.

The cyclic communication task 700 sends an MCM alive telegram 710 every second. The task also checks at decision 720 for incoming telegrams, and, if an incoming telegram is a challenge telegram, the challenge result is calculated at element 730 and transmitted back to the SMM.

The MCM health condition monitoring task is a higher priority task than the cyclic communication task 700 and the MCM main task. The MCM health condition monitoring task prepares the MCM alive-telegram for the SMM, and, in the alive check task 800, checks if the SMM alive-telegram arrives in time. The priority of this task is higher than all other MCM tasks. In the alive check task 800, a safe condition 810 is triggered when an SMM alive telegram is not received (decision 820) after two cycles.

A semaphore from the cyclic communication task (element 740 of FIG. 7) to the alive check task (element 840 of FIG. 8) is used to synchronize those two tasks to make sure that the MCM can detect that the SMM is alive and sending alive-telegrams every second.

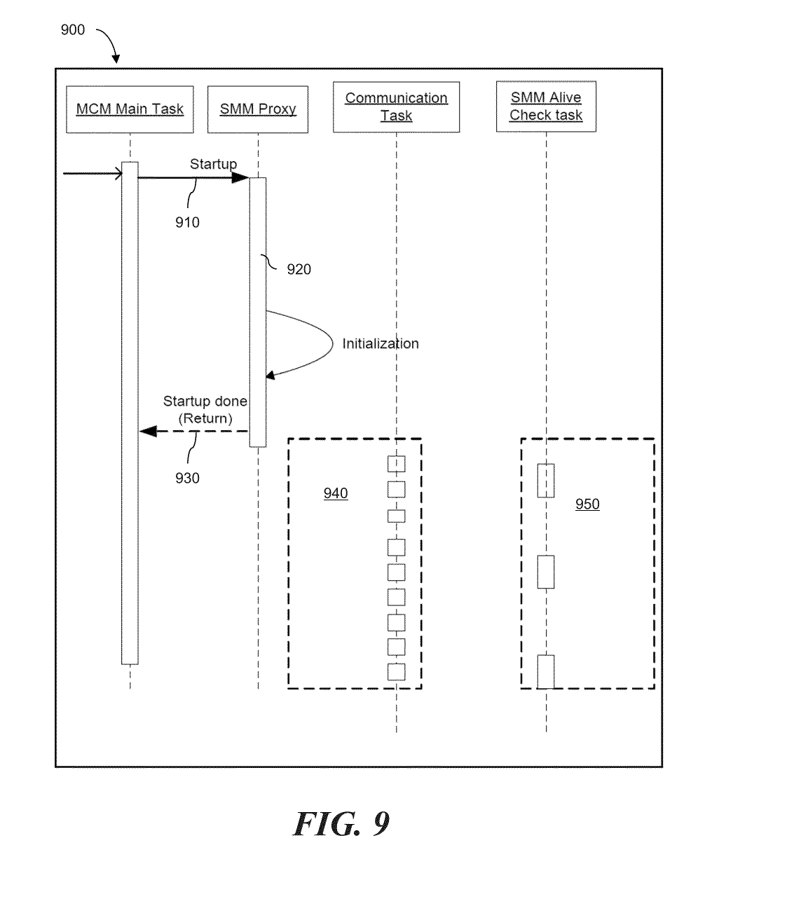

A sequence diagram 900 shown in FIG. 9 illustrates the start-up use case for the MCM. The MCM main task sends a start-up message 910 to the SMM proxy, which performs an initialization task 920. After initialization is complete, the SMM proxy returns a message 930 indicating that startup is done. The communication tasks 940 and SMM alive check tasks 950 are then performed in loops by the SMM proxy.

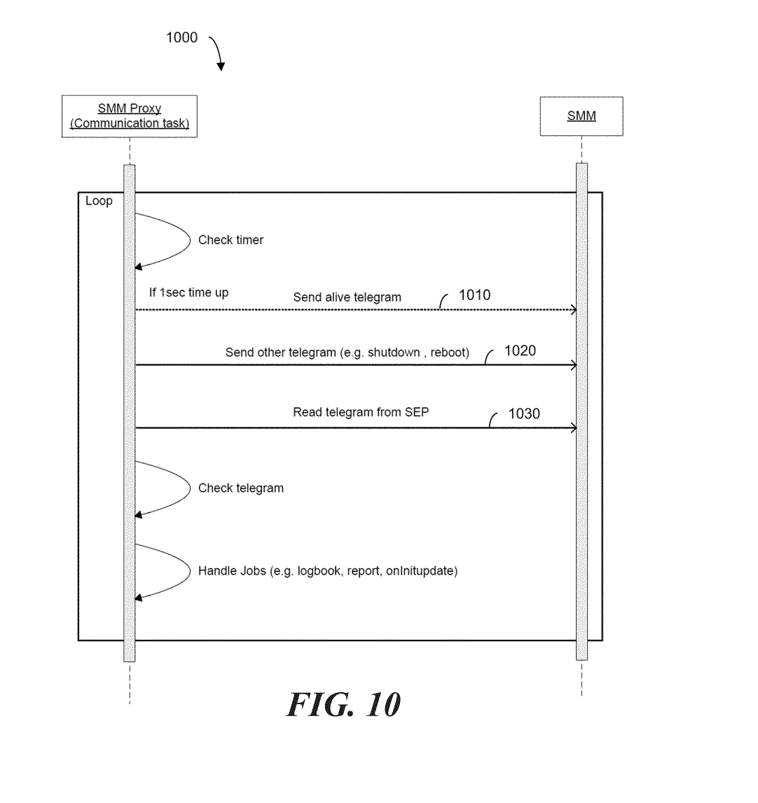

A runtime use case of the SMM proxy is illustrated by the sequence diagram 1000 of FIG. 10. The loop includes sending an alive telegram 1010 to the SMM every second, sending other telegrams 1020 and reading telegrams 1030 from the SMM.

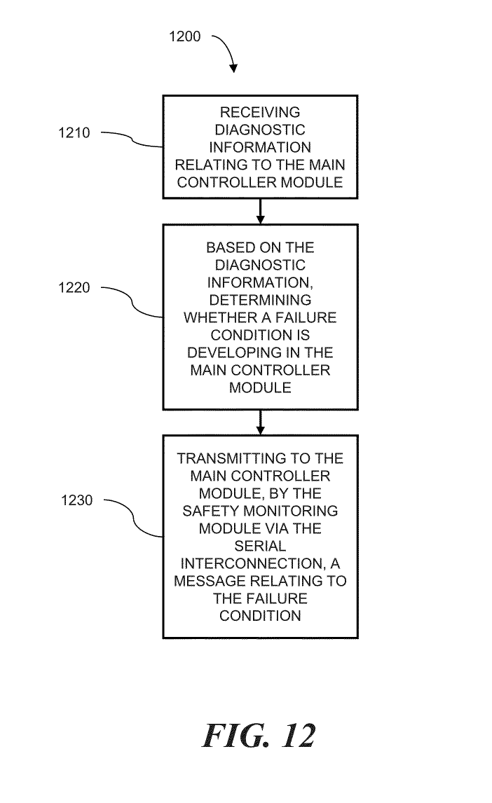

An exemplary method for monitoring a status of an embedded computer system in accordance with the present disclosure is illustrated by the flow chart 1200 of FIG. 12. The embedded computer system includes a main controller module and a safety monitoring module independent from the main controller module. The term “independent,” as used herein with reference to the two processor modules, means that the two modules are able to execute programs independently without interaction. The failure of one of the independent modules does not affect a program executing on the other, except via messaging between the two modules.

Diagnostic information relating to the main controller module is received (operation 1210) at the safety monitoring module via a serial interconnection between the safety monitoring module and a proxy sub-module of the main controller module. The serial interconnection may utilize telegram messages comprising security mechanisms to verify telegram integrity. The diagnostic information may include information about responses in alive telegram exchanges between the safety monitoring module and the main controller module.

Based on the diagnostic information, the safety monitoring module determines (operation 1220) whether a failure condition is developing in the main controller module. That determination may include evaluating the diagnostic information using a prognostic model constructed using a simulation of failure modes off line. In addition to the diagnostic information, the safety monitoring module may also base the determination whether a failure condition is developing on supply voltage information and temperature information relating to the main controller module.

The safety monitoring module then transmits (operation 1230) to the main controller module via the serial interconnection, a message relating to the failure condition. The message may be an instruction to place the module in a safe state.

Disclosed is an innovative safety monitoring enabled architecture for embedded systems, which integrates self-monitoring into the current embedded system technology. The proposed embedded system framework has the capability to do self-fault detection, diagnosis, and prediction and can be applied in safety critical applications.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. For example, the architecture may be incorporated into embedded systems used in the rail industry, in automotive and aviation applications, and in other applications of embedded systems where safety and reliability are important. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A method for monitoring a status of an embedded computer system comprising a main controller module and a safety monitoring module independent from the main controller module, the method comprising:
receiving, at the safety monitoring module via a serial interconnection between the safety monitoring module and a proxy sub-module of the main controller module, diagnostic information relating to the main controller module;
by the safety monitoring module, based on the diagnostic information, determining whether a failure condition is developing in the main controller module; and
transmitting to the main controller module, by the safety monitoring module via the serial interconnection, a message relating to the failure condition.

2. The method of claim 1, further comprising:
receiving, at the safety monitoring module, supply voltage information and temperature information relating to the main controller module; and
wherein determining whether a failure condition is developing in the main controller module is further based on the supply voltage information and temperature information.

3. The method of claim 1, wherein determining that a failure condition is developing in the main controller module further comprises:
evaluating the diagnostic information using a prognostic model constructed using a simulation of failure modes off line.

4. The method of claim 1, wherein the serial interconnection utilizes telegram messages comprising security mechanisms to verify telegram integrity.

5. The method of claim 1, wherein the diagnostic information relating to the main controller module comprises information about responses in alive telegram exchanges between the safety monitoring module and the main controller module.

6. The method of claim 5, further comprising:
receiving, at the main controller module via the serial interconnection, responses in the alive telegram exchanges between the safety monitoring module and the main controller module; and
by the main controller module, based on the responses, determining whether a failure condition is developing in the safety monitoring module.

7. The method of claim 6, wherein the proxy sub-module of the main controller module further comprises a health condition monitoring task for preparing alive telegrams for transmission to the safety monitoring module, and for checking whether the responses in the alive telegram exchange arrive on time, the health condition monitoring task having a higher priority than a main task of the main controller module.

8. The method of claim 1, further comprising:
transmitting, by the safety monitoring module to the main controller module via the serial interconnection, a calculation challenge;
receiving, by the safety monitoring module, a calculation challenge response from the main controller module; and
by the safety monitoring module, based on the calculation challenge response, determining whether a failure condition is developing in the safety monitoring module.

9. The method of claim 8, further comprising:
by the main controller module, ignoring a second calculation challenge received from the safety monitoring module before transmitting the calculation challenge response.

10. The method of claim 8, further comprising:
by the safety monitoring module, ignoring a second calculation challenge response received from the main controller module before transmitting a new calculation challenge.

11. The method of claim 1, further comprising:
updating firmware of the safety monitoring module using a send and reply communication protocol via the serial interconnection.

12. The method of claim 1, wherein the serial interconnection between the safety monitoring module and a proxy sub-module of the main controller module comprises a cyclic communication task run by the proxy sub-module, the cyclic communication task having a same priority as a main task of the main controller module.

13. An embedded computer system, comprising:
a main controller processing unit;
main controller computer readable media containing computer readable instructions that, when executed by the main controller processing unit, cause the main controller processing unit to control an electromechanical system;
a safety monitoring module proxy sub-module within the main controller processing unit for performing communication tasks;
a safety monitoring processing unit independent from the main controller processing unit and in communication with the main controller processing unit via a serial interconnection between the safety monitoring processing unit and the proxy sub-module of the main controller processing unit; and
computer readable media containing computer readable instructions that, when executed by the safety monitoring processing unit, cause the safety monitoring processing unit to perform the following operations:
receiving, via the serial interconnection, diagnostic information relating to the main controller processing unit;
determining, based on the diagnostic information, whether a failure condition is developing in the main controller processing unit; and
transmitting to the main controller processing unit, via the serial interconnection, a message relating to the failure condition.

14. The embedded computer system of claim 13, further comprising:
a voltage monitor configured to measure supply voltage information to the main controller processing unit; and
a temperature monitor configured to measure temperature information relating to the main controller processing unit; and
wherein determining whether a failure condition is developing in the main controller processing unit is further based on the supply voltage information and temperature information.

15. The embedded computer system of claim 13, wherein determining that a failure condition is developing in the main controller processing unit further comprises:
evaluating the diagnostic information using a prognostic model constructed using a simulation of failure modes off line.

16. The embedded computer system of claim 13, wherein the diagnostic information relating to the main controller processing unit comprises information about responses in alive telegram exchanges between the safety monitoring processing unit and the main controller processing unit.

17. The embedded computer system of claim 16, wherein the main controller computer readable media further contains computer readable instructions that, when executed by the main controller processing unit, cause the main controller processing unit to perform the following operations:
receiving, via the serial interconnection, responses in the alive telegram exchanges between the safety monitoring processing unit and the main controller processing unit; and
based on the responses, determining whether a failure condition is developing in the safety monitoring processing unit.

18. The embedded computer system of claim 13, wherein the operations further comprise:
transmitting, to the main controller module via the serial interconnection, a calculation challenge;
receiving a calculation challenge response from the main controller module; and
based on the calculation challenge response, determining whether a failure condition is developing in the safety monitoring module.

19. The embedded computer system of claim 18, wherein the operations further comprise:
ignoring a second calculation challenge response received from the main controller module before transmitting a new calculation challenge.

20. A non-transitory computer-usable medium having computer readable instructions stored thereon for execution by a safety monitoring processing unit of an embedded computer system, to perform operations for monitoring safety of the embedded computer system, comprising:
receiving, via a serial interconnection between the safety monitoring processing unit and a proxy sub-module of a main controller processing unit, diagnostic information relating to the main controller processing unit;
based on the diagnostic information, determining whether a failure condition is developing in the main controller processing unit; and
transmitting to the main controller processing unit, via the serial interconnection, a message relating to the failure condition.
